(19) United States
(12) Patent Application Publication
(10) Pub. No.: US 2014/0278802 A1
(43) Pub. Date: Sep. 18, 2014

(54) PRODUCING AND PROVIDING DATA FOR RENDERING A TRAVEL COST HEATMAP

(71) Applicant: Google Inc., Mountain View, CA (US)

(72) Inventor: Luke David MACPHERSON, Pyrmont (AU)

(73) Assignee: Google Inc., Mountain View, CA (US)

(21) Appl. No.: 14/144,419

(22) Filed: Dec. 30, 2013

Related U.S. Application Data
(60) Provisional application No. 61/794,583, filed on Mar. 15, 2013.

(51) Int. Cl. G06Q 30/02

(52) U.S. Cl. CPC G06Q 30/0205
USPC 705/7.34

(57) ABSTRACT

The disclosed subject matter relates to computer implemented methods for producing and providing data for rendering a travel cost heatmap. In one example, a method includes receiving an origin location. The method further includes receiving one or more cost-constraints. The cost-constraint(s) is a maximum acceptable cost. The method further includes calculating a travel cost associated with travel from the origin location to each of a plurality of destination locations. The method further includes associating the calculated travel costs respectively with each of the plurality of destination locations. The method further includes comparing the respective calculated travel cost with the cost-constraint(s). The method further includes associating, based on the comparison, a visual indicator with the each of the plurality of destination locations. The method further includes providing, for rendering a travel cost heatmap, the data produced as a result of the techniques described above.

### CROSS-REFERENCES TO RELATED APPLICATIONS

The present application claims the benefit of U.S. Provisional Patent Application Ser. No. 61/794,583, titled “Producing and Providing Data for Rendering a Travel Cost Heatmap,” filed on Mar. 15, 2013, which is hereby incorporated by reference in its entirety for all purposes.

### BACKGROUND

Travel has various costs associated therewith. Costs associated with travel can include, for example, time that must be spent traveling, distance that must be traveled, energy (e.g., electricity, fuel) that must be used to power a vehicle used for traveling, and money (e.g., fares, wear and tear to vehicle used for traveling).

### SUMMARY

The disclosed subject matter relates to producing and providing data for rendering a travel cost heatmap. The method comprises receiving, using one or more computing devices, an origin location, and receiving, using the one or more computing devices, at least one cost-constraint, wherein the at least one cost-constraint comprises a maximum acceptable cost. The method further comprises calculating, using the one or more computing devices, for a plurality of destination locations, a respective travel cost associated with traveling from the received origin location to each of the plurality of destination locations, and associating, using the one or more computing devices, with the each of the plurality of destination locations, the respective calculated travel cost. The method further comprises comparing, using the one or more computing devices, the respective calculated travel cost with the at least one cost-constraint, and associating, using the one or more computing devices, based on the comparing, a visual indicator with the each of the plurality of destination locations. The method further comprises providing, using the one or more computing devices, for rendering a travel cost heatmap, data produced as a result of the steps of receiving the origin location, receiving the at least one cost-constraint, calculating, associating, comparing, and associating, wherein the travel cost heatmap comprises the visual indicator associated with the each of the plurality of destination locations.

The disclosed subject matter further relates to a system for producing and providing data for rendering a travel cost heatmap. The system comprises one or more processors, and a machine-readable medium comprising instructions stored therein, which when executed by the processors, cause the processors to perform operations comprising producing data for rendering a travel cost heatmap. The operations further comprise providing the data for rendering the travel cost heatmap to a client device via a network interface, the data for rendering the travel cost heatmap defining different fill parameters for different portions of the heatmap.

The disclosed subject matter further relates to a machine-readable medium comprising instructions stored therein, which when executed by a machine, cause the machine to perform operations comprising calculating, for each of a plurality of destination locations, a travel cost associated with traveling from an origin location to the each of the plurality of destination locations. The operations further comprise determining, for each calculated travel cost, which one of a plurality of cost ranges that the calculated travel cost falls in, wherein each of the plurality of cost ranges is associated with a respective fill parameter, and identifying, for each of the plurality of destination locations, a corresponding portion of a map. The operations further comprise associating, with the corresponding portion of the map, the respective fill parameter corresponding to the one of the plurality of cost ranges that the calculated travel cost falls in, and providing to a second computing device, via a network interface of a first computing device, data produced as a result of the steps of calculating, determining, identifying, and associating, wherein the second computing device is configured to render in a graphical user interface, the data as a heatmap of calculated travel costs.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### DESCRIPTION OF DRAWINGS

Certain features of the subject technology are set forth in the appended claims. However, for purpose of explanation, several embodiments of the subject technology are set forth in the following figures.

FIG. 1 illustrates an example of an architecture for producing and providing data for rendering a travel cost heatmap.

FIG. 2 is a block diagram illustrating examples of client devices and a server in the architecture of FIG. 1 according to certain aspects of the disclosure.

FIGS. 3A-B illustrate examples of processes for producing and providing data for rendering a travel cost heatmap.

FIG. 4A-B illustrate examples of heatmaps rendered based on data produced by the processes of FIGS. 3A-B.

FIG. 5 conceptually illustrates an example electronic system with which some aspects of the subject technology can be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

I. Overview

As described above, travel has various costs associated therewith. Costs associated with travel can include, for example, the amount of time involved with traveling, the distance traveled, the energy (e.g., electricity, fuel) used for traveling, and money (e.g., financial cost of fares, financial cost of wear and tear to vehicle used for traveling, financial cost of energy) spent for traveling.

In many instances, travel costs increase in a linear fashion with respect to the distance from the origin location to the destination location. For example, an individual driving a car can expect to spend more in travel costs for a trip of 10 miles, than for a trip of 5 miles. However, all travel costs may not necessarily increase in such a linear fashion. For example, an individual may pay the same bus fare to travel from one bus stop to any one of the other bus stops on the bus route. However, the further the individual travels on the bus, the more time would be spent traveling.

Calculations involving travel costs can become increasingly complex by taking into consideration costs such as the cost of parking, checking in luggage, purchasing food on longer trips, and costs of traveling to and from transportation hubs (e.g., airports, train stations). It may not be feasible for an individual to perform various complex calculations before deciding upon a destination location, and choosing how to reach that destination.

The subject disclosure describes systems and techniques for producing and providing data for rendering a travel cost heatmap. In one example, a user can provide or allow location information to be received by a server. The user can also provide cost-constraint(s) e.g., time, money, energy, distance, and so on, to determine which destination locations can be traveled to within the provided cost-constraints. Based on the received origin location and the received cost-constraint(s), the server can produce and provide data for rendering a travel cost heatmap. The data for rendering the travel cost heatmap can be sent by the server to a computing device configured to render the travel cost heatmap. The user can, based on the rendered travel cost heatmap, select a particular destination location to travel to.

In one example, a system can receive, from a client device of a user, an origin location together with cost-constraint(s) indicating a maximum acceptable cost. For example, the cost-constraint(s) can correspond to a financial cost (e.g., a maximum acceptable cost expressed in currency), a spatial cost (e.g., a maximum acceptable distance to travel) and/or a temporal cost (e.g., a maximum acceptable amount of time). The system can calculate, for a plurality of destination locations, a respective travel cost (e.g., a lowest possible cost) associated with traveling from the received origin location to each of the plurality of destination locations. The system can associate, with the each of the plurality of destination locations, the respective calculated travel cost, and can compare the respective calculated travel cost with the cost-constraint(s).

Based on the comparison, the system can associate a visual indicator with the each of the plurality of destination locations. For example, the visual indicator can be a color, with a warmth of the color corresponding to the comparison of the cost-constraint(s) and the respective calculated travel cost. The system can provide, for rendering a travel cost heatmap, data produced as a result of the steps of receiving the origin location, receiving the cost-constraint(s), calculating, associating, comparing, and associating. The travel cost heatmap can include the visual indicator (e.g., color) associated with the each of the plurality of destination locations.

II. Example Client-Server Network Environments for Producing and Providing Data for Rendering a Travel Cost Heatmap

FIG. 1 illustrates an example of an architecture 100 for producing and providing data for rendering a travel cost heatmap. The architecture 100 includes client devices 110 and servers 170 connected over a network 140.

The client devices 110 can be, for example, mobile computers, tablet computers, mobile devices (e.g., a smartphone or PDA), desktop computers, set top boxes (e.g., for a television), video game consoles, or any other devices having appropriate processing capabilities, communications capabilities, and memory. Each client device 110 is configured to include an input device for accepting user input, and an output device to display information to the user.

The client devices 110 can be connected to the network 140. The network 140 can include any one or more of a personal area network (PAN), a local area network (LAN), a campus area network (CAN), a metropolitan area network (MAN), a wide area network (WAN), a broadband network (BBN), the Internet, and the like. Further, the network 140 can include, but is not limited to, any one or more of the following network topologies, including a bus network, a star network, a ring network, a mesh network, a star-bus network, tree or hierarchical network, and the like.

Some of the client devices 110 can be location-aware. The term “location-aware” as used herein encompasses its plain and ordinary meaning, including, but not limited to any device which is capable of determining its location. For example, a smartphone 110L illustrated in FIG. 1 is capable of determining its location based on a GPS signal received from GPS satellites 120. That is, the smartphone 110L may be considered a location-aware client device.

Location-awareness may be achieved through a variety of location-sensing techniques. For example, the smartphone 110L may be capable of determining its location based on techniques involving multi-lateration. The location-sensing techniques may be based on and/or applied to signals received from communications towers 122. Similarly, the smartphone 110L may be capable of determining its location based on IP geolocation techniques.

Location-awareness may be achieved through indirect methods that may not rely on communications signals received from communications towers 122. As an example, a Wi-Fi enabled mobile device (e.g., a smartphone) that is not connected to a communications tower 122 may be able to determine its position based on Wi-Fi broadcast SSIDs and/or MAC addresses of devices broadcasting the Wi-Fi signals nearby.

While some of the client devices 110 (e.g., the smartphone 110L) may be location-aware, other client devices 110 may not be location-aware, or may be temporarily unable to determine their location. For example, if the client device does not have the requisite hardware (e.g., a GPS receiver) or the requisite software (e.g., for performing IP geolocation techniques), the client device may not be location-aware. As an example, a desktop computer 110N illustrated in FIG. 1 may not be location-aware.

The servers 170 can be for example, stand-alone servers, shared servers, dedicated servers, cluster/grid servers (e.g., a server farm), or cloud servers. Each of the servers 170 may include one or more processors, communications modules, and memory. The servers 170 may be configured to distribute workload (e.g., for loadbalancing) across multiple servers.

It should be noted that regardless of how location information is obtained, appropriate efforts may be undertaken to inform the user of the use of that information, and to protect the user's privacy rights.

For example, an explanatory notice may be provided to the user, providing notification of the use of location information. Furthermore, in example aspects, the user may be requested to provide explicit consent so that location information is not used unless the user grants permission. Additionally, the user may be notified that the user may withdraw consent at any time.

As another example, the user may be reminded periodically of the user of the user's location information. The reminder may be communicated as a message, for example, an email message, a text message, and/or a voice message. The reminder may be visual. The visual reminder may be, for example, a dot, an arrow, a compass, a bar, or the like, that is displayed within a graphical user interface to indicate to the user that the user's location information is being used.

In addition to the examples provided above, steps may be taken to anonymize and/or encrypt user-specific information such as IP addresses, cookie IDs, location information and the like. Similarly, efforts may be undertaken to limit the retention of, and to allow the user to modify (e.g., alter, delete), the user's location information.

FIG. 2 is a block diagram 200 illustrating examples of client devices 110 and a server 170 in the architecture 100 of FIG. 1 according to certain aspects of the disclosure.

In FIG. 2, two examples of client computing devices 110 are provided in order to illustrate a variety of configurations of a client computing device 110. The example of the first computing device 110N is provided to illustrate a scenario where a client computing device 110 is unable to autonomously determine its location, for example, because of a user-configurable setting and/or because of a lack of hardware or software required for such a determination. Thus, for any location-based processing, the first client computing device 110N would require location information to be received from an external source. The external source can be, for example, a user, a location-aware peripheral, or another computing device.

The example of the second computing device 110L is provided to illustrate a scenario where a client computing device 110 is able to autonomously determine its location, for example, because of a user-configurable setting or because of a presence of hardware or software required for such a determination. Thus, for any location-based processing, the second client computing device 110L would be able to autonomously determine its location. It should be noted that while the second client computing device 110L may not require location information from an external source, it would still be capable of receiving such information.

The first client computing device 110N includes an input device 202N, an output device 204N, a processor 220N, a communications module 222N, and memory 240N. The input device 202N can be a touchscreen, a mouse, a keyboard, an audio input device (e.g., a microphone), a video input device (e.g., a camera, a motion detector), or any other device to enable a user to supply input 206N (e.g., location information) to the first client computing device 110N. The output device 204N can be a display screen. Input 206N received via the input device 202N can be processed locally on the client device 110N and/or the server 170.

The first client device 110N is connected to the network 140 via a communications module 222N. The communications module 222N is configured to interface with the network 140 to send and receive information, such as data, requests, responses, and commands to other devices on the network 140. The communications module 222N can be, for example, a modem or Ethernet card.

The memory 240N includes a graphical user interface 250N which can be used by a user to interact with the computing device 110N and/or the server 170, and can be used to display information to the user. The graphical user interface 250N may be installed locally at the computing device 110N and/or downloaded from the server 170. The memory 240N further includes software instructions 242N that can be read by the processor 220N to enable interaction with the server 170. For example, the software instructions 242N can include an operating system or an application (e.g., a web browser) that can be processed by the processor 220N. Data generated or stored at the client computing device 110N can be stored as data 244N.

The first client computing device 110N provides location information 246N to the server 170. The location information 246N may be based on user input 206N, received from a location-aware peripheral (e.g., a GPS receiver), or received from another computing device such as another client computing device 110 or a server 170. Location information 246N can be an origin location from which the user wishes to travel. In addition to the location information 246N, the user can provide one or more cost-constraints 248N.

The second client computing device 110L is similar to the first client computing device 110N in some respects. For example, the second client computing device 110L also includes an input device 202L, an output device 204L, a processor 220L, a communications module 222L, and memory 240L. The input device 202L can be a touchscreen, a mouse, a keyboard, an audio input device (e.g., a microphone), a video input device (e.g., a camera, a motion detector), or any other device to enable a user to supply input 206L to the second client computing device 110L. The output device 204L can be a display screen. Input 206L received via the input device 202L can be processed locally on the client device 110L and/or the server 170L.

The second client computing device 110L is connected to the network 140 via a communications module 222L. The communications module 222L is configured to interface with the network 140 to send and receive information, such as data, requests, responses, and commands to other devices on the network 140. The communications module 222L can be, for example, a modem or Ethernet card.

The memory 240L includes a graphical user interface 250L which can be used by a user to interact with the second client computing device 110L and/or the server 170, and can be used to display information to the user. The graphical user interface 250 may be installed locally at the second client computing device 110 and/or downloaded from the server 170. The memory 240L further includes software instructions 242L that can be read by the processor 220L to enable interaction with the server 170. For example, the software instructions 242L can include an operating system or an application (e.g., a web browser) that can be processed by the processor 220L. Data generated or stored at the client computing device 110L can be stored as data 244L.

The second client computing device 110L further includes a location-aware module 224. The location-aware module 224 is capable of determining its geographic location. For example, the location-aware module 224 may use a GPS signal received from GPS satellites 120 to determine its location. As another example, the location-aware module 224 may rely on wireless triangulation techniques to determine its location. The location-aware module 224 can provide location information 246L to the server 170. In addition, the user can provide one or more cost-constraints 248L.

The server 170 includes a memory 280, a processor 260, and a communications module 262. The memory 280 includes software instructions that can be read by the processor 260 to implement a travel cost module 282. The travel cost module 282 receives an origin location. The origin location can be location information (e.g., 246N, 246L) that is received from a client computing device 110 (e.g., 110N, 110L). The travel cost module 282 receives one or more cost-constraints (e.g., 248N, 248L). A cost-constraint is a maximum acceptable cost. The travel cost module 282 calculates a travel cost associated with travel from the origin location to each of a plurality of destination locations. The travel cost module 282 associates the calculated travel costs respectively with each of the plurality of destination locations. The travel cost module 282 compares the respective calculated travel cost with the cost-constraint(s) (e.g., 248N, 248L). The travel cost module 282 associates, based on the comparison, a visual indicator with the plurality of destination locations. The travel cost module 282 provides, for rendering a travel cost heatmap, the data (e.g., travel cost data 284) produced as a result of the steps of receiving the origin location, receiving the cost-constraint(s) (e.g., 248N, 248L), calculating the travel cost(s), comparing the calculated travel costs with the cost-constraint(s) (e.g., 248N, 248L), and associating the visual indicators.

The server 170 is connected to the network 140 via a communications module 262. The communications module 262 is configured to interface with the network 140 to send and receive information, such as data, requests, responses, and commands to other devices on the network 140. The communications module 262 can be, for example, a modem or Ethernet card.

The processor 260 of the server 170 is configured to execute instructions, such as instructions physically coded into the processor 260, instructions read from the memory 280, or a combination of both. As an example, the processor 260 of the server 170 executes instructions for producing and providing data (e.g., travel cost data 284) for rendering a travel cost heatmap.

Once the instructions from the memory 280 are loaded, the processor 260 is configured to receive an origin location. The origin location can be defined by location information (e.g., 246N, 246L) that is received from a client computing device 110 (e.g., 110N, 110L). The processor 260 is configured to receive one or more cost-constraints (e.g., 248N, 248L). A cost-constraint (e.g., 248N, 248L) is a maximum acceptable cost. The processor 260 is further configured to calculate a travel cost associated with travel from the origin location to each of a plurality of destination locations. The processor 260 is further configured to associate the calculated travel costs respectively with each of the plurality of destination locations. The processor 260 is further configured to compare the respective calculated travel cost with the cost-constraint(s) (e.g., 248N, 248L). The processor 260 is further configured to associate, based on the comparison, a visual indicator with the plurality of destination locations. The processor 260 is further configured to provide, for rendering a travel cost heatmap, the data (e.g., travel cost data 284) produced as a result of the steps of receiving the origin location, receiving the cost-constraint(s) (e.g., 248N, 248L), calculating the travel cost(s), comparing the calculated travel costs with the cost-constraint(s) (e.g., 248N, 248L), and associating the visual indicators.

In one example, a computing system (e.g., server 170) includes a processing device (e.g., processor 260) and a network interface (e.g., communications module 262). The processing device (e.g., processor 260) is configured to produce data (e.g., travel cost data 284) for rendering a travel cost heatmap. The processing device (e.g., processor 260) is further configured to provide the data (e.g., travel cost data 284) to a client device (e.g., client computing device 110) via the network interface (e.g., communications module 262). The data (e.g., travel cost data 284) defines different fill parameters for different portions of the heatmap. A fill parameter is a form of a visual indicator.

The processing device (e.g., processor 260) of the computing system (e.g., server 170) can be configured to execute instructions such as instructions physically coded into the processing device (e.g., processor 260), instructions read from the memory 280, or a combination of both. As an example, the processing device (e.g., processor 260) can execute instructions for producing and providing data (e.g., travel cost data 284) for rendering a travel cost heatmap.

To produce the data (e.g., travel cost data 284), the processing device (e.g., processor 260) determines an origin location. The processing device (e.g., processor 260) can determine the origin location based on location information (e.g., 246N, 246L) received from a client computing device 110 (e.g., 110N, 110L). The processing device (e.g., processor 260) calculates, for each of a plurality of destination locations, a travel cost associated with traveling from the origin location (e.g., 246N, 246L) to the destination location. The processing device (e.g., processor 260) determines, for each calculating travel cost, which one of a plurality of cost ranges that the calculated travel cost falls in, wherein each cost range is associated with a different fill parameter. The processing device (e.g., processor 260) identifies, for each destination location, a portion of a map that contains the destination location, and associates the fill parameter corresponding to the cost range of travel to the destination location with that portion of the map.

III. Example Processes for Producing and Providing Data for Rendering a Travel Cost Heatmap

FIGS. 3A-B illustrate examples of processes 300A-B for producing and providing data for rendering a travel cost heatmap. It should be noted that although processes 300A-B are described herein with reference to the systems of FIGS. 1 and 2, processes 300A-B are not limited to such, and can be performed by other systems and/or configurations.

FIG. 3A illustrates one example of process 300A for producing and providing data (e.g., travel cost data 284) for rendering a travel cost heatmap.

At block 310, travel cost module 282 on the server 170 receives an origin location. The origin location can be defined by location information (e.g., 246N, 246L) that is received from a client computing device 110 (e.g., 110N, 110L). The location information (e.g., 246N, 246L) can be based on user input (e.g., 206N, 206L), or received from a location-aware peripheral (e.g., a GPS receiver). If the client computing device is location-aware (e.g., 110L), the location-information (e.g., 246L) can be determined by a location-aware module (e.g., 224) of that client-computing device (e.g., 110L).

The origin location may be received from the server 170. That is, the server 170 may be configured to estimate or determine the origin location of the user. To that end, a variety of techniques, for example, IP geolocation, using a location provided by another device associated with the user, and the like, may be implemented at the server 170.

At block 315, the travel cost module 282 on the server 170 receives one or more constraints (e.g., 248N, 248L)

A cost-constraint (e.g., 248N, 248L) indicates a maximum acceptable cost for a particular type of cost of travel. A cost-constraint (e.g., 248N, 248L) can correspond to any one of several types of costs of travel. For example, the cost-constraint (e.g., 248N, 248L) can be used to express a maximum acceptable cost of time, distance, energy, or money.

When the cost-constraint (e.g., 248N, 248L) is financial, it is expressed as a currency amount. That is, when the cost-constraint (e.g., 248N, 248L) is financial, a money amount can be used to indicate the maximum acceptable amount of money to be utilized in traveling. The financial cost can arise out of fares, such as bus fares, taxi fares, airline tickets, railway tickets and so on. The financial cost can arise out of others monetary aspects of travel such as costs of parking, wear and tear of a vehicle, purchasing fuel for a fuel-based vehicle, and recharging costs for an electricity-based vehicle.

Financial costs can also take into consideration the monetary value of a user's time. For example, a user who earns a high wage may be pressed for time, and therefore may find it more cost effective to dedicate his time to performing gainful tasks rather than travel. For such a user, it may be more advantageous to spend more money on a fare for a faster means of travel, rather than to save money on a fare in exchange for having to spend more time in travel. The converse may be true of a user for whom money is a resource more scarce than time.

When the cost-constraint (e.g., 248N, 248L) is temporal, it is expressed as an amount of time. That is, when the cost-constraint (e.g., 248N, 248L) is temporal, an amount of time can be used to indicate the maximum acceptable amount of time to be utilized in traveling.

When the cost-constraint (e.g., 248N, 248L) is spatial, it is expressed as an amount of distance. That is, when the cost-constraint (e.g., 248N, 248L) is spatial, an amount of distance can be used to indicate the maximum acceptable amount of distance to be traveled.

A cost-constraint (e.g., 248N, 248L) may also be based on energy to be expended during travel. That is, when the cost-constraint (e.g., 248N, 248L) can be used to indicate the maximum acceptable amount of energy to utilized in traveling. Units of energy to be expended may be dependent upon the types of energy used by the underlying means of transportation, or modes of travel. For example, when a user travels by expending his own energy (e.g., by walking, running, rollerblading, bicycling, rowing), the units may be expressed in calories. However, when the user travels using a fuel-based vehicle, the amount of energy may be expressed as an amount of fuel required for travel. When the user travels using an electricity based vehicle, the amount of energy may be expressed in kilowatt-hours.

When the cost-constraint (e.g., 248N, 248L) is related to the environment, it may be expressed in terms of, for example, greenhouse gas emissions, thermal energy emissions, carbon footprint values, and so on.

At block 320, the travel cost module 282 on the server 170 calculates a travel cost associated with travel from the origin location to each of a number of destination locations. That is, for each destination location, the travel cost module 282 calculates the cost of travel from the origin location to that destination location.

A destination location can correspond to geographic location expressed in geographical coordinates. A destination location can also correspond to a geographic location corresponding to an address (e.g., a residential address or a commercial address). The shortest distance between two potential destination locations may depend upon the resolution or accuracy of the positioning system used by the server 170.

The travel cost calculated by the travel cost module 282 is of the type identified by the cost-constraint(s) (e.g., 248N, 248L). For example, if the cost-constraint (e.g., 248N, 248L) is temporal, then the travel cost would be in terms of the time required for travel.

The travel cost associated with travel from the origin location to a particular destination location may be, for example, the lowest possible cost associated with traveling from the origin location to the destination location. Other approaches to the travel cost may be based on an average cost or a median cost, associated with traveling from the origin location to the destination location.

The travel cost may also be based on, for example, a particular timeframe. For example, the travel cost may be based on a moving average. The use of a travel cost that is based on a particular timeframe (e.g., a moving average) provides for calculations that are based on recent data.

The travel cost may be based on, for example, realtime data. Thus, the travel cost would be based on the most current conditions. For example, if traffic on a particular street is slow (e.g., due to an accident or construction), then the temporal cost of traveling through that street would be greater than for a street where traffic is moving faster.

The travel cost module 282 may also include in the calculated travel cost, the additional cost of travel associated with returning from a particular destination location to the origin location. That is, the calculated travel cost may correspond to the cost of travel associated with a round trip from the origin location to the destination location.

At block 325, the travel cost module 282 on the server 170 associates the calculated travel costs respectively with each of the plurality of destination locations. That is, for each destination location, the travel cost module 282 associates with that particular destination location, the travel cost calculated at block 320 for that destination location.

At block 330, the travel cost module 282 on the server 170 compares the respective calculated travel cost with the cost-constraint(s) (e.g., 248N, 248L). That is, for each destination location, the travel cost module 282 determines whether the cost of travel to that particular destination location is less than, equal to, or greater than the maximum acceptable value expressed as a cost-constraint (e.g., 248N, 248L).

At block 335, based on the comparison of block 330, the travel cost module 282 on the server 170 associates a visual indicator with each of the destination locations.

The visual indicator can be a color, pattern, texture, and so on. The visual indicator provides a visual indication of the comparison, performed at block 330, between the cost-constraint (e.g., 248N, 248L) and the respective calculated travel cost. That is, the visual indicator associated with a particular destination location, visually indicates the results of the comparison of the cost-constraint(s) (e.g., 248N, 248L) to the cost(s) of traveling from the origin location to that destination location.

The various degrees of the visual indicator can correspond to the magnitude of the difference between the cost-constraint (e.g., 248N, 248L) and the travel cost. As an example, when the visual indicator is a color, the warmth of the color can correspond to the magnitude of the difference between the cost-constraint (e.g., 248N, 248L) and the calculated travel cost. Thus, a warmer color (e.g., red, orange) may be associated with a destination location with a travel cost greater than the cost-constraint (e.g., 248N, 248L), and a cooler color (e.g., blue, purple) may be associated with a destination location with a travel cost lesser than the cost-constraint (e.g., 248N, 248L).

As another example of using color as a visual indicator, the various degrees can be expressed in grayscale, where the magnitude of the difference between the cost-constraint (e.g., 248N, 248L) and the calculated travel cost is expressed in levels of blackness on a white background.

Similarly, when the cost-constraint (e.g., 248N, 248L) is a pattern, the density of the pattern may correspond to the magnitude of difference between the cost-constraint (e.g., 248N, 248L) and the calculated travel cost. The pattern can be, for example, dots (e.g., as used in halftoning), lines (e.g., as used in hatching, cross-hatching), alignment of lines (e.g., an angle of the line compared to the horizontal axis), tessellated shapes, and so on.

Data 284 produced in blocks 310 through 335 may be stored on the server 170. At block 340, the travel cost module 282 on the server 170, provides, for rendering a travel cost heatmap, this data 284 produced as the result of blocks 310 through 335. The travel cost heatmap includes visual indicators associated with the destination locations.

FIG. 3B illustrates another example of process 300B for producing and providing data for rendering a travel cost heatmap.

Process 300B is similar to process 300A in that blocks 350 and 355 of process 300B are similar to blocks 310 and 320 respectively of process 300A.

At block 360, the travel cost module 282 on the server 170 determines, for each calculated travel cost, which range of costs it falls within. Each cost range is associated with a different fill parameter. A fill parameter is one example of a visual indicator. The fill parameter can be a color or a pattern. Similar to the visual indicator, the various degrees of the fill parameter, can correspond to the cost range.

At block 365, the travel cost module 282 on the server 170 identifies a portion of a map that contains a particular destination location, and associates the fill parameter corresponding to the cost range of travel to that destination location with that portion of the map.

It should be noted that aspects of processes 300A-B may be combined. For example, the visual indicators of process 300A may be converted to fill parameters by configuring the travel cost module 282 to include in process 300A, block 360 of process 300B.

There may be several effects of combining aspects of processes 300A and 300B. For example, one effect may be due to a quantization aspect of associating ranges of travel costs with destinations. Association of ranges of travel costs with destinations, rather than specific values, may lead to a reduction in the amount of data 284 produced and provided by the travel cost module 282.

A travel cost heatmap rendered based on ranges of travel costs may have less resolution or detail than a travel cost heatmap rendered based on specific values. However, the lower resolution may provide for distinct boundaries between destination locations with different travel costs.

The data 284 produced as a result of processes 300A-B for rendering the travel cost heatmap may define a map layer, or a map image. The data 284 may be provided, for example to a client computing device 110 via a network interface of the communications module 262.

A graphical user interface (e.g., 250N, 250L) can be configured to render the data 284 as a heatmap. The graphical user interface (e.g., 250N, 250L) can correspond to an operating system or an application (e.g., a web browser). The graphical user interface (e.g., 250N, 250L) may include a graphical user interface element for providing and/or altering the maximum acceptable cost(s) of the cost-constraint(s) (e.g., 248N, 248L). The graphical user interface element can be for example, a slider, a radio button, a text input box, or any other similar method of receiving input (e.g., 206N, 206L) from a user.

When a maximum acceptable cost is provided and/or altered using the graphical user interface element, the blocks of process 300A-B may be repeated for the new value of the maximum acceptable cost of the cost-constraint (e.g., 248N, 248L).

An input (e.g., 206N, 206L) can correspond to a particular destination location displayed in the travel cost heatmap. Based on input (e.g., 206N, 206L) corresponding to a particular destination location, an itemization of the travel costs associated with that destination location can be provided for display within the graphical user interface (e.g., 250N, 250L).

For example, when the input device (e.g., 202N, 202L) is a mouse, a user may use the mouse to perform a hover, click, or double-click operation on a particular destination location within the travel cost heatmap. Based on the mouse operation (e.g., 206N, 206L), a breakdown of travel costs may be provided for display.

As another example, when the input device (e.g., 202N, 202L) is a touchscreen, the user input (e.g., 206N, 206L) may be in the form of a tap, press-and-hold, double-tap, or multi-gesture operation.

IV. Example Graphical User Interfaces of Travel Cost Heatmaps Rendered Based on Produced Data

FIGS. 4A-B illustrate examples of heatmaps 400A-B rendered based on data 284 produced by processes 300A-B.

In this example, a college student is interested to know where he can travel without having to drive his own car, and within a limited budget. The college that the student attends, is in the countryside, which is a rural area several miles from the nearest metropolitan area. The college student is using web browser on a laptop computer 110 to interact with the server 170 via the graphical user interface (e.g., 250N, 250L) of a travel cost website.

The college student specifies the address of his college dormitory as the origin location 410. The address of the college student's dormitory is received by the travel cost module 282 on the server 170.

The college student indicates that he is interested in traveling to a destination location at a financial cost no greater than $20. That is, the user indicates the maximum acceptable financial cost of travel to be $20. The college student specifies the amount using a slider 470 displayed on the travel cost website. The college student further selects an option to present financial costs in increments of $5.

The travel cost module 282 calculates a financial travel cost of traveling from the college dormitory 410 to a number of destination locations. In this example, the travel cost module 282 calculates financial costs of travel to destination locations radiating outward from the college dormitory 410.

The travel cost module 282 in this example is configured to assume that distances up to half a mile can traveled on foot. That is, the travel cost module 282 calculates the financial cost of travel to locations within a half mile radius of the college dormitory 410 to be $0. Locations within a half mile radius of the college dormitory 410 are illustrated in FIG. 4A as region 430.

A train route 420 has a train stop 422 near the college dormitory 410. The transit fare of the train is $2.50. That is, for $2.50, the college student can travel to any stop on the train route 420. The travel cost module 282 takes the train route 420 into consideration and calculates the financial cost of travel to train stop 424 to be $2.50. Similarly, the travel cost module 282 calculates the financial cost of travel to train stop 426 to be $2.50. The travel cost module 282 then calculates financial costs of travel onward from train stops 424 and 426. Based on the assumption that the college student can walk up to half a mile, the travel cost module 282 calculates the financial costs of travel to destinations within a half mile radius of each of train stops 424 and 426 to be the same as the financial cost of traveling to the train stops 424 and 426.

Because there are no other forms of public transit (e.g., bus) available in this rural area, and because the college student is not willing to drive his own car, the travel cost module 282 calculates financial costs of travel to destination locations beyond the half mile mark based on taxi fares.

Region 432 represents destination locations which can be reached in a taxi for fares (financial travel costs) of up to $5. Region 434A marked with a dotted circle represents the half mile mark from train stop 424. Locations in region 434A have a financial travel cost of $2.50 associated with them. Locations in region 434B have costs of $2.51 through $5. However, because the website is configured to group locations based on financial costs in increments of $5, regions 434A and 434B are rendered as a contiguous region. Region 436A and 436B are similarly rendered as a contiguous region.

As the distance increases from the college dormitory 410, and train stops 424, and 426, the taxi fares increase accordingly. For example region 438 represents locations with financial travel costs of $5.01 through $10. In this example, when regions with similar costs intersect, they are merged to form a contiguous region. For example, region 440, 442, and 444 are a result of merging of regions with similar costs. Region 446 indicates locations with costs greater than $20, the maximum financial cost of travel acceptable to the college student.

The travel cost module 282 associates with each destination location, the calculated financial cost of travel from the college dormitory 410 to that destination location.

The travel cost module 282 compares the financial cost of travel to each destination location with the financial cost-constraint (e.g., 248N, 248L) of $20. That is, the travel cost module 282 determines whether the calculated financial cost of travel to a particular destination location is less than, equal to, or greater than the maximum acceptable value of $20.

Based on the comparison, the travel cost module 282 associates a pattern with each destination location. In this example, the pattern is associated for each destination location that falls within a range of financial travel costs. The financial cost ranges in this example are expressed in increments of $5. Thus, the travel cost module 282 associates a pattern with destination locations corresponding to financial travel cost ranges of (a) $0 to $5, (b) $5.01 to $10, (c) $10.01 to $15, (d) $15.01 to $20, and (e) $20.01 and greater. No pattern, or a blank pattern, is associated with locations that have a financial travel cost of $0.

Data 284 produced by the server 170 is provided to the college student's laptop computer 110 as part of the travel cost website. The web browser on the laptop computer 110 renders the travel cost heatmap 400A illustrated in FIG. 4A.

The college student then selects another viewing option which provides the travel cost heatmap 400B illustrated in FIG. 4B. This time, the college student removes the financial cost constraint of $20. In this example, rather than ranges, financial travel costs are represented by dots of various sizes in proportion to the costs. The size of the dots in this example is automatically selected based on the size of the browser window, and zoom level.

V. Example System for Producing and Providing Data for Rendering a Travel Cost Heatmap

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

FIG. 5 conceptually illustrates an electronic system with which some implementations of the subject technology are implemented. Electronic system 500 can be a server, computer, phone, PDA, laptop, tablet computer, television with one or more processors embedded therein or coupled thereto, or any other sort of electronic device. Such an electronic system includes various types of computer readable media and interfaces for various other types of computer readable media. Electronic system 500 includes a bus 508, processing unit(s) 512, a system memory 504, a read-only memory (ROM) 510, a permanent storage device 502, an input device interface 514, an output device interface 506, and a network interface 516.

Bus 508 collectively represents all system, peripheral, and chipset buses that communicatively connect the numerous internal devices of electronic system 500. For instance, bus 508 communicatively connects processing unit(s) 512 with ROM 510, system memory 504, and permanent storage device 502.

From these various memory units, processing unit(s) 512 retrieves instructions to execute and data to process in order to execute the processes of the subject disclosure. The processing unit(s) can be a single processor or a multi-core processor in different implementations.

ROM 510 stores static data and instructions that are needed by processing unit(s) 512 and other modules of the electronic system. Permanent storage device 502, on the other hand, is a read-and-write memory device. This device is a non-volatile memory unit that stores instructions and data even when electronic system 500 is off. Some implementations of the subject disclosure use a mass-storage device (such as a magnetic or optical disk and its corresponding disk drive) as permanent storage device 502.

Other implementations use a removable storage device (such as a floppy disk, flash drive, and its corresponding disk drive) as permanent storage device 502. Like permanent storage device 502, system memory 504 is a read-and-write memory device. However, unlike storage device 502, system memory 504 is a volatile read-and-write memory, such a random access memory. System memory 504 stores some of the instructions and data that the processor needs at runtime. In some implementations, the processes of the subject disclosure are stored in system memory 504, permanent storage device 502, and/or ROM 510. For example, the various memory units include instructions for producing and providing data for rendering a travel cost heatmap according to various embodiments. From these various memory units, processing unit(s) 512 retrieves instructions to execute and data to process in order to execute the processes of some implementations.

Bus 508 also connects to input and output device interfaces 514 and 506. Input device interface 514 enables the user to communicate information and select commands to the electronic system. Input devices used with input device interface 514 include, for example, alphanumeric keyboards and pointing devices (also called “cursor control devices”). Output device interfaces 506 enables, for example, the display of images generated by the electronic system 500. Output devices used with output device interface 506 include, for example, printers and display devices, such as cathode ray tubes (CRT) or liquid crystal displays (LCD). Some implementations include devices such as a touchscreen that functions as both input and output devices.

Finally, as shown in FIG. 5, bus 508 also couples electronic system 500 to a network (not shown) through a network interface 516. In this manner, the computer can be a part of a network of computers (such as a local area network (“LAN”), a wide area network (“WAN”), or an Intranet, or a network of networks, such as the Internet. Any or all components of electronic system 500 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of exemplary approaches. Based upon design preferences, it is understood that the specific order or hierarchy of steps in the processes may be rearranged, or that some illustrated steps may not be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Headings and subheadings, if any, are used for convenience only and do not limit the subject disclosure. Features under one heading may be combined with features under one or more other heading and all features under one heading need not be used together. Features under one heading may be combined with features under one or more other heading and all features under one heading need not be used together.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A computer-implemented method for producing and providing data for rendering a travel cost heatmap, the method comprising:
receiving, using one or more computing devices, an origin location;
receiving, using the one or more computing devices, at least one cost-constraint, wherein the at least one cost-constraint comprises a maximum acceptable cost;
calculating, using the one or more computing devices, for a plurality of destination locations, a respective travel cost associated with traveling from the received origin location to each of the plurality of destination locations;
associating, using the one or more computing devices, with the each of the plurality of destination locations, the respective calculated travel cost;
comparing, using the one or more computing devices, the respective calculated travel cost with the at least one cost-constraint;
associating, using the one or more computing devices, based on the comparing, a visual indicator with the each of the plurality of destination locations; and
providing, using the one or more computing devices, for rendering a travel cost heatmap, data produced as a result of the steps of receiving the origin location, receiving the at least one cost-constraint, calculating, associating, comparing, and associating, wherein the travel cost heatmap comprises the visual indicator associated with the each of the plurality of destination locations.

2. The computer-implemented method of claim 1, wherein the respective travel cost is the lowest possible cost associated with traveling from the received origin location to the each of the plurality of destination locations.

3. The computer-implemented method of claim 1, wherein the travel cost further comprises a cost associated with traveling from each of plurality of destination locations to the received origin location.

4. The computer-implemented method of claim 1, wherein the visual indicator is a color, and wherein a warmth of the color corresponds to the comparison of the cost-constraint and the respective calculated travel cost.

5. The computer-implemented method of claim 1, wherein the cost-constraint is a financial cost-constraint, and wherein maximum acceptable cost is expressed as a currency amount.

6. The computer-implemented method of claim 1, wherein the cost-constraint is a spatial cost-constraint, and wherein maximum acceptable cost is expressed as a distance.

7. The computer-implemented method of claim 1, wherein the cost-constraint is temporal, and wherein the maximum acceptable cost is expressed as an amount of time.

8. The computer-implemented method of claim 1, wherein the data is provided to a computing device, and wherein the computing device is configured to render in a graphical user interface, the data as a heatmap of calculated travel costs.

9. The computer-implemented method of claim 8, wherein the graphical user interface comprises a graphical user interface element for altering the maximum acceptable cost.

10. The computer-implemented method of claim 9, wherein the graphical user interface element comprises a slider.

11. The computer-implemented method of claim 9, wherein an alteration in the maximum acceptable cost causes the steps of receiving, calculating, associating, comparing, associating, and providing of claim 1 to be repeated for the received origin location using the altered maximum acceptable cost.

12. The computer-implemented method of claim 1, further comprising:
receiving, using the one or more computing devices, an input from an input device, wherein the input corresponds to at least one of the plurality of destination locations displayed in the heatmap; and
providing, using the one or more computing devices, for display, an itemization of the respective travel cost associated with the at least one of the plurality of destination locations.

13. A system for producing and providing data for rendering a travel cost heatmap, the system comprising:
one or more processors; and
a machine-readable medium comprising instructions stored therein, which when executed by the processors, cause the processors to perform operations comprising:
producing data for rendering a travel cost heatmap; and
providing the data for rendering the travel cost heatmap to a client device via a network interface, the data for rendering the travel cost heatmap defining different fill parameters for different portions of the heatmap.

14. The system of claim 13, wherein the data for rendering the travel cost heatmap is produced by:
(a) determining an origin location;
(b) calculating, for each of a plurality of destination locations, a travel cost associated with traveling from the origin location to the destination location;
(c) for each calculated travel cost, determining which one of a plurality of cost ranges that the calculated travel cost falls in, each cost range associated with a different fill parameter; and
(d) for each destination location:
identifying a portion of a map that contains the destination location;
and associating the fill parameter that corresponds to the cost range of travel to the destination location with that portion of the map.

15. The system of claim 13, wherein the data for rendering the travel cost heatmap is a map image.

16. The system of claim 13, wherein the data for rendering the travel cost heatmap comprises data defining a map layer.

17. The system of claim 13, wherein the different fill parameters define different colors or patterns.

18. A machine-readable medium comprising instructions stored therein, which when executed by a machine, cause the machine to perform operations comprising:
calculating, for each of a plurality of destination locations, a travel cost associated with traveling from an origin location to the each of the plurality of destination locations;
determining, for each calculated travel cost, which one of a plurality of cost ranges that the calculated travel cost falls in, wherein each of the plurality of cost ranges is associated with a respective fill parameter;
identifying, for each of the plurality of destination locations, a corresponding portion of a map;
associating, with the corresponding portion of the map, the respective fill parameter corresponding to the one of the plurality of cost ranges that the calculated travel cost falls in; and
providing to a second computing device, via a network interface of a first computing device, data produced as a result of the steps of calculating, determining, identifying, and associating, wherein the second computing device is configured to render in a graphical user interface, the data as a heatmap of calculated travel costs.

19. The machine-readable medium of claim 18, wherein the respective fill parameter defines at least one of a color or a pattern.

20. The machine-readable medium of claim 18, wherein the data for rendering the heatmap of calculated travel costs comprises data defining a map layer.
